(19) United States
(12) Patent Application Publication
(10) Pub. No.: US 2026/0170106 A1
(43) Pub. Date: Jun. 18, 2026

(54) MULTIPLE-FACTOR AUTHENTICATION BASED ON DETECTED CONDITIONS

(71) Applicant: Motorola Mobility LLC, Chicago, IL (US)

(72) Inventors: Panduranga Reddy Pailla, Bangalore (IN); Vijayprakash Idlur, Bangalore (IN); Ranjeet Gupta, Plainfield, IL (US)

(73) Assignee: Motorola Mobility LLC, Chicago, IL (US)

(21) Appl. No.: 18/982,238

(22) Filed: Dec. 16, 2024

(51) Int. Cl. G06F 21/31

(52) U.S. Cl. CPC G06F 21/31

(57) ABSTRACT

In aspects of multiple-factor authentication based on detected conditions, a device deactivates multiple-factor authentication for access to the device in response to one or more of the device being in a trusted location or the device being connected to a trusted device. In some cases, the unsecure condition is associated with one or more of an event at the trusted location, an environment of the trusted device, or an environment of the device. The device detects, based on application data associated with the device, an unsecure condition associated with the access to the device. The device activates, in response to detecting the unsecure condition, the multiple-factor authentication for the access to the device.

### BACKGROUND

Devices, such as smart devices, mobile devices (e.g., cellular phones, tablet devices, smartphones), consumer electronics, wearable devices, and the like, can be implemented for use in a wide range of environments and for a variety of different applications. The devices may display, store, or otherwise be accessible to obtain secure data. Accordingly, the devices may implement authentication processes, such as passcodes.

### BRIEF DESCRIPTION OF THE DRAWINGS

Implementations of the techniques for multiple-factor authentication based on detected conditions are described with reference to the following Figures. The same numbers may be used throughout to reference like features and components shown in the Figures:

FIGS. 1 and 2 illustrate example systems for multiple-factor authentication based on detected conditions in accordance with one or more implementations as described herein.

FIGS. 3 through 5 illustrate example flowcharts for multiple-factor authentication based on detected conditions in accordance with one or more implementations as described herein.

FIG. 6 illustrates an example user interface for multiple-factor authentication based on detected conditions in accordance with one or more implementations as described herein.

FIGS. 7 and 8 illustrate examples of methods for multiple-factor authentication based on detected conditions in accordance with one or more implementations of the techniques described herein.

FIG. 9 illustrates various components of an example device that can be used to implement the techniques for multiple-factor authentication based on detected conditions as described herein.

### DETAILED DESCRIPTION

Implementations of techniques for multiple-factor authentication based on detected conditions are described herein. In some examples, a device (e.g., a mobile device, a client device, a wearable device, or any other device) can implement one or more applications or services that provide authentication fort access to the device to improve security of the device. The authentication may include multiple-factor authentication, including, but not limited to, two-factor authentication. For example, the device implements multiple-factor authentication that combines biometric authentication (e.g., fingerprint or facial recognition) with a passcode or password. In some cases, the device can activate (e.g., enable) or deactivate (e.g., disable, pause, suspend) the multiple-factor authentication according to one or more conditions. For example, the device activates the multiple-factor authentication when the device is not in a trusted location or establishes a connection with a device that is not a trusted device. In some other examples, the device deactivates the multiple-factor authentication when the device is in a trusted location or connected to a trusted device. Activating and deactivating multiple-factor authentication reduces the use of computational resources (e.g., processing, memory) for the device when in the trusted location or connected to the trusted device, while maintaining security at the device when the device is not in the trusted location or is connected to a device that is not trusted.

In some examples, activating and deactivating multiple-factor authentication may introduce security vulnerabilities when unexpected security threats are present (e.g., unsecure conditions are met). For example, the device may be in a trusted location, but there may be an event at the trusted location that includes one or more users that are not authorized to access the device. Additionally, or alternatively, the device may be connected to a trusted device, but there may be multiple users that can access the trusted device and that are not authorized to access the device. Thus, if one or more unsecure conditions are met (e.g., one or more unknown users or devices are within a threshold distance from the device or a trusted device connected to the device) while multiple-factor authentication is deactivated, then the device is susceptible to unauthorized access by other users or devices present in the trusted location or that have access to the trusted device connected to the device.

As described herein, to improve security of a device, the device can dynamically activate or deactivate multiple-factor authentication based on detected conditions. The device may deactivate multiple-factor authentication when in a trusted location or connected to a trusted device to reduce computational resource usage. The device can detect unsecure conditions within trusted environments, such as unexpected social gatherings or the presence of unknown users or devices. For example, the device may detect an unsecure condition by analyzing application data (e.g., calendar data, messaging data, and/or personal knowledge base or graph data) to identify an event occurring at the trusted location, monitoring nearby devices to detect unfamiliar signals, using one or more audio sensors to detect multiple voices or unexpected noise levels, and/or using one or more image sensors (e.g., cameras) to identify the presence of unknown individuals, among other examples. Upon detecting an unsecure condition, the device automatically activates multiple-factor authentication to prevent unauthorized access to the device, even if previously deactivated due to being in a trusted environment. In some examples, the device may display a notification that indicates the multiple-factor authentication is enabled.

Detecting one or more unsecure conditions and activating (e.g., reactivating) multiple-factor authentication provides advantages over conventional authentication systems that do not monitor for the unsecure conditions when in trusted locations or connected to trusted devices. By dynamically responding to changing environments and events, the device can improve security in trusted environments, which reduces the risk of unauthorized access to the device. The system proactively detects potential threats and adapts authentication processes automatically (e.g., rather than based on user input).

While features and concepts of the described techniques for multiple-factor authentication based on detected conditions can be implemented in any number of different devices, systems, environments, and/or configurations, implementations of the techniques for multiple-factor authentication based on detected conditions are described in the context of the following example devices, user interfaces, systems, and methods.

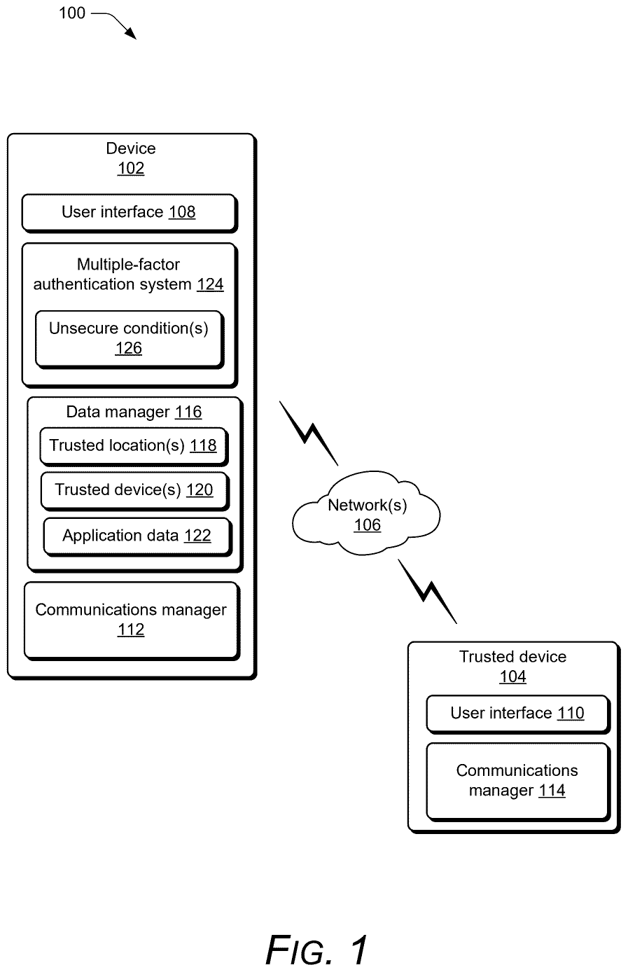

FIG. 1 illustrates an example system 100 for multiple-factor authentication based on detected conditions, as described herein. The example system 100 includes a device 102 and a trusted device 104, where the device 102 and the trusted device 104 are interconnectable via one or more networks 106. Although the example system 100 illustrates the device 102 and the trusted device 104, in some examples, the device 102 is not connected to a trusted device 104. A device 102 and a trusted device 104 may range from a full resource device with substantial memory and processor resources to a low-resource device with reduced memory and/or processing resources. Although in instances in the following discussion reference is made to a device 102 and a trusted device 104, respectively, in the singular, a device 102 and a trusted device 104 may also be representative of multiple different devices. The device 102 and a trusted device 104 may include one or more features in addition to, or as an alternative to, the features illustrated in the example system 100.

In some examples, the device 102 and/or the trusted device 104 are examples of a smartphone, a laptop, a tablet, a server device, a mobile phone, a wearable device, and/or any other type of wireless device, mobile device, or wired device. Wearable devices may include a variety of form factors and functionalities designed to be worn on or close to a body of a user. Examples of wearable devices may include smartwatches, fitness trackers, smart glasses, smart jewelry (rings, necklaces, earrings, etc.), smart clothing (e.g., shirts or shoes with embedded sensors), head-mounted displays, cameras, smart earbuds, and health monitoring devices, among other examples. The device 102 and/or the trusted device 104 can be implemented with various components, such as a processor system and memory, as well as any number and combination of different components as further described with reference to the example device shown in FIG. 9.

For example, the device 102 may include a user interface 108, and the trusted device 104 may include a user interface 110. The user interface 108 and the user interface 110 may provide for visual, auditory, and/or tactile input and output. For example, a user may provide input via the user interface 108 and/or the user interface 110. Additionally, or alternatively, the device 102 and/or the trusted device 104 may provide output (e.g., display, broadcast the output) via the user interface 108 and the user interface 110, respectively. The user interface 108 and/or the user interface 110 may include, but is not limited to, a graphical user interface (GUI), a touchscreen, a display, a keyboard, one or more hardware and/or software buttons, microphones, speakers, haptic feedback mechanisms, or other input/output (I/O) components that provide for users to control device functions, access applications, and receive information from the device 102 and the trusted device 104. In some cases, the user interface 108 and/or the user interface 110 may be customizable, such that a user may adjust settings, arrange icons, or personalize the appearance of the user interface 108 and/or the user interface 110.

In one or more implementations, the device 102 and the trusted device 104 include various radios for wireless communication (e.g., via the networks 106). For example, the device 102 and the trusted device 104 may include a Bluetooth (BT) and/or Bluetooth Low Energy (BLE) transceiver and/or a near field communication (NFC) transceiver. The device 102 and the trusted device 104 can also include a Wi-Fi radio, a GPS radio, and/or any type of device communication interfaces. The device 102 and the trusted device 104 may establish a connection (e.g., a wireless connection via the networks 106, including Bluetooth or Wi-Fi). In some cases, the device 102 may implement a pairing process to identify and authenticate the trusted device 104. The pairing process may include exchanging unique identifiers or cryptographic keys between the device 102 and the trusted device 104. For example, the device 102 may use Bluetooth pairing to establish an initial connection with the trusted device 104. During this process, the device 102 and/or the trusted device 104 may exchange security keys and store them (e.g., at a local database) for future authentication. The device 102 may associate one or more paired devices (e.g., including the trusted device 104) as trusted at the local database.

The device 102 may implement a user-initiated trust establishment process. For example, the device 102 may receive input (e.g., via the user interface 108) that designates one or more additional devices as trusted. The device 102 may store identifiers corresponding to the trusted devices, among other information about the trusted devices (e.g., including the trusted device 104). In some cases, the device 102 may utilize various types of unique device identifiers to recognize and authenticate trusted devices. For example, the identifiers may include, but are not limited to, media access control (MAC) addresses, which are unique hardware identifiers assigned to network interfaces. Additionally, or alternatively, the identifiers may include Bluetooth addresses, digital certificates or public key infrastructure, and/or identifiers created during a pairing or registration process (e.g., user-defined names or randomly generated tokens), among other examples. In some cases, the device 102 may utilize a combination of identifiers to enhance the reliability of trusted device recognition and reduce the likelihood of unauthorized access.

In some examples, the device 102 may implement a multiple-factor authentication (e.g., verification) process to ensure the authenticity of the trusted device 104. The multiple-factor authentication of a trusted device 104 may include the device 102 checking a digital certificate of the trusted device 104, verifying a firmware version of the trusted device 104, and/or conducting another type of authentication protocol. Additionally, or alternatively, the device 102 may use Wi-Fi network information to identify trusted devices. For example, if both the device 102 and the trusted device 104 are connected to a designated trusted Wi-Fi network, then the device 102 may consider the connection secure. In some cases, the device 102 may employ machine learning algorithms to recognize patterns in device connections and automatically designate frequently connected devices as trusted over time. The adaptive approach to designating trusted devices may provide for the device 102 to build a network of trusted devices based on usage patterns and user behavior. Once a trust relationship is established, the device 102 may store information identifying the trusted devices and use the information for future authentication processes, providing for simplified access or reduced security processes when interacting with the trusted device 104.

In some examples, the device 102 may implement a communications manager 112 for wireless communication, and the trusted device 104 may implement a communications manager 114 for wireless communication. The communications manager 112 at the device 102 and the communications manager 114 at the trusted device 104 facilitate the establishment and maintenance of wireless connections between the devices for secure authentication purposes. The communications manager 112 at the device 102 may handle initial connection setup with trusted devices, manage the exchange of authentication data, and coordinate activation and deactivation of multiple-factor authentication based on an environment of the device 102 and/or an environment of the trusted device 104. The communications manager 114 at the trusted device 104 may accept incoming connection requests from the device 102, verifying a trusted status of the device 102, and exchanging data to confirm a presence of the device 102 in a trusted environment. Both communications managers implement security protocols to ensure encrypted and authenticated data transfer, manage bandwidth allocation, and handle any network-related issues or disconnections.

The data manager 116 at the device 102 collects and processes information related to trusted locations 118, trusted devices 120, and application data 122. For trusted locations 118, the data manager 116 may utilize GPS data, Wi-Fi network information, or other location-based signals to identify and store locations that a user has designated as trusted and/or that the device 102 has identified as trusted. The data manager 116 may implement learning algorithms (e.g., machine learning models and/or artificial intelligence (AI) models) to automatically recognize frequently visited secure locations. For trusted devices 120, the data manager 116 may collect and store unique identifiers, such as Bluetooth addresses or device certificates, of devices that a user has authorized as trusted and/or that the device has identified as trusted. The application data 122 is gathered by the data manager 116 from various applications on the device 102, such as calendar entries, messaging history, personal knowledge base or graph data, or social media activity, which may indicate potential security risks or changes in an environment of the device 102.

Trusted locations 118 refer to physical places where the device 102 is considered to be in a secure environment, such as a home of a user, an office of a user, or other frequently visited locations by a user. For example, the device 102 may store a home address of a user or geographic coordinates of a workplace of a user as trusted locations. Trusted devices 120 may include a list of electronic devices that a user and/or the device 102 has designated as secure and reliable. The trusted device 120 may include, but are not limited to, a personal computer of a user, smart home devices, or a smartphone of an individual trusted by the user. For example, a Bluetooth system of a car of a user or a smartwatch of a user may be registered as trusted devices 120. Application data 122 includes information from various applications and services on the device 102 that may be relevant to security decisions for activating and/or deactivating multiple-factor authentication. The application data 122 may include, but is not limited to, calendar data indicating an event at a trusted location, email confirmations of travel plans, or social media check-ins at new locations.

A personal knowledge base or graph may refer to a structured collection of information related to a user, encompassing behaviors, preferences, routines, and interactions with various devices and applications. The personal knowledge base or graph may be continuously updated and refined through machine learning algorithms that analyze patterns in activities of the user, device usage, and digital footprint. The personal knowledge base or graph data may be used for activating and/or deactivating multiple factor authentication by analyzing locations, schedules, and device usage patterns, among other information stored in the personal knowledge base or graph, to determine when to adjust multiple-factor authentication for the device 102. For example, if the personal knowledge base or graph indicates that the user works from home on Fridays, then the multiple-factor authentication system 124 may automatically deactivate multiple factor authentication when the device 102 is used at the home location on that day. Additionally, or alternatively, if the personal knowledge base or graph shows that the user rarely uses the device 102 for a time period, then an attempt to access the device 102 during the time period may trigger the activation of multiple factor authentication (e.g., even if the device 102 is in a trusted location). In some cases, the personal knowledge base or graph may include information about social connections of the user, providing for the multiple-factor authentication system 124 to adjust multiple-factor authentication based on the presence of known individuals and/or devices.

The multiple-factor authentication system 124 is a security framework implemented by the device 102 to verify an identity of a user through two or more distinct authentication methods. The device 102 may implement the multiple-factor authentication system 124 by combining different authentication processes, such as an input (e.g., a password or pin provided by a user) and biometric information collected from a user (e.g., biometric data like fingerprints or facial recognition). For example, the device 102 may use both a fingerprint scan and a pin when the device 102 is not in a trusted location. In some examples, the device 102 may use facial recognition in combination with detecting the presence of a trusted device to authenticate a user. The device 102 may perform facial recognition of a user using a camera to collect images and then analyzing the images to determine whether a user authorized to access the device 102 is present in the images. If successful, then the device 102 may then check for a signal from a trusted device 104 of the user. If the facial recognition matches an authorized user and the trusted device 104 is detected within a threshold distance from the device 102, then the authentication processes is considered successful. The device 102 may grant access to one or more applications and/or services of the device 102.

The multiple-factor authentication system 124 dynamically manages authentication processes by activating or deactivating multiple-factor authentication based on an environment of the device 102, including based on whether the device 102 is within one of the trusted locations 118 or connected to one of the trusted devices 120. When the device 102 enters a geographically defined trusted location, such as a home or office of a user, the multiple-factor authentication system 124 may deactivate one or more authentication processes. Deactivating one or more authentication processes may include removing (e.g., canceling, terminating) one or more of the factors of authentication. For example, if the device 102 is implementing a multiple-factor authentication process that includes verifying biometric information of a user and verifying a passcode provided as input, then the device 102 may use one of the biometric information or the passcode if the multiple-factor authentication is deactivated (e.g., not both). The device 102 may determine whether the device 102 is within a trusted location using GPS data, Wi-Fi signals, or other location-based technologies that confirm a presence of the device 102 within defined trusted location. Additionally, or alternatively, when the device 102 establishes a connection with a trusted device 104, such as a personal laptop or a smart home system, the device 102 may deactivate the multiple-factor authentication. The device 102 may verify the connection using a combination of Bluetooth, NFC, or Wi-Fi, where the device 102 recognizes stored identifiers (e.g., MAC addresses or security certificates) that confirm the device is trusted. Upon successful verification, the multiple-factor authentication system 124 may deactivate the multiple-factor authentication, which reduces computational resources related to the repetitive authentication process. If the device 102 exits (e.g., moves outside of) a trusted location or disconnects from a trusted device, then the multiple-factor authentication system 124 reactivates the multiple-factor authentication.

In some examples, deactivating the multiple-factor authentication processes according to trusted locations and trusted devices may lead to security vulnerabilities. For example, a device 102 may deactivate multiple-factor authentication when in a home of a user, but may fail to account for scenarios (e.g., environments) where unauthorized individuals gain access to the home. Similarly, trusted devices may be compromised or shared with others. In some cases, incorporating context-aware and adaptive authentication mechanisms may enhance security of the device 102, while maintaining user convenience and reducing computational resources.

The multiple-factor authentication system 124 may detect unsecure conditions 126 when multiple-factor authentication is deactivated (e.g., in a trusted location or when connected to a trusted device). In some cases, the multiple-factor authentication system 124 may continuously monitor an environment of the device 102 and/or the trusted device 104 and user behavior patterns to identify potential security risks (e.g., unsecure conditions, security threats). The system may analyze application data 122, such as calendar entries, location information, personal knowledge base or graph data, and communication logs, to detect anomalies or events that may indicate an unsecure condition. For example, if the device 102 is in a trusted location but a calendar indicates a meeting with additional individuals, then the multiple-factor authentication system 124 may flag the date and time of the meeting as an unsecure condition. The multiple-factor authentication system 124 may activate (e.g., reactivate) the multiple-factor authentication for the duration of the meeting or event. The multiple-factor authentication system 124 may gather real-time data about an environment of the device 102 and/or the trusted device 104. For example, the device 102 and/or the trusted device 104 may include various sensors, such as audio sensors, image sensors (e.g., cameras), accelerometers, gyroscopes, heart rate monitors, GPS receivers, and cameras. The sensors provide for the device 102 to collect (e.g., obtain, receive) sensor data and/or receive sensor data collected by the trusted device 104. The device 102 may analyze the sensor data to detect one or more unsecure conditions in an environment of the device 102 and/or the trusted device 104. For example, the device 102 may use audio sensors to detect multiple voices or unexpected noise levels that indicate a presence of unauthorized individuals. The device 102 may additionally, or alternatively, implement image sensors to identify unauthorized individuals within a threshold distance from the device 102 and/or the trusted device 104. In some cases, the device 102 may monitor for changes to network traffic patterns or attempts to access sensitive applications or data. Additionally, or alternatively, the device 102 may use motion sensors to detect changes in orientation that indicate the device 102 is picked up or otherwise handled by an unauthorized user.

In some examples, the unsecure conditions 126 may include, but are not limited to, a change to an environment of the device 102 or the trusted device 104 and/or an identified event that compromises a security of the device 102 or data of the device 102 (e.g., even when the device 102 is in a trusted location or connected to a trusted device 104). Examples of unsecure conditions 126 may include, but are not limited to, an event at a trusted location, a detection of an unknown Bluetooth, cellular, or Wi-Fi signal within a threshold distance from the device 102 (e.g., indicating a presence of an unfamiliar device), an unexpected change in a location of the device 102 within a trusted area (e.g., movement from a home office to a less secure part of a house during a time when a user is typically at work), a change in network connectivity, multiple failed login attempts on connected accounts, and/or activation of certain sensitive applications, among other examples. By continuously monitoring for the unsecure conditions 126, the multiple-factor authentication system 124 can respond to potential security threats when operating in a reduced security state (e.g., when the multiple-factor authentication is deactivated).

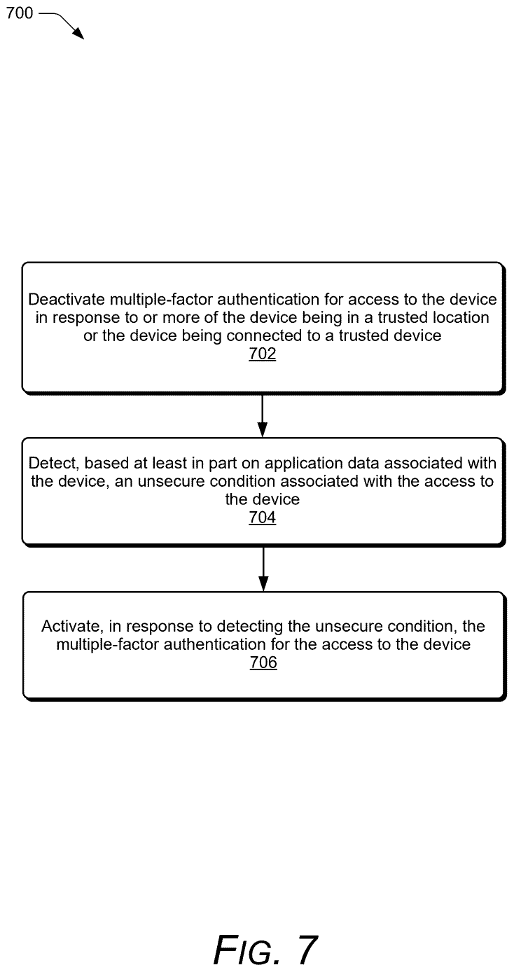

In some examples, if the device 102 detects an unsecure condition 126 and the multiple-factor authentication is deactivated at the device, then the device 102 may reactivate the multiple-factor authentication. The device 102 may continue to monitor for the unsecure conditions 126 and may deactivate the multiple-factor authentication when the unsecure condition 126 is no longer detected. In some cases, the device 102 may display notifications via the user interface 108 and/or the user interface 110 to inform a user about activation of the multiple-factor authentication. For example, if an unsecure condition 126 is detected, then the device 102 may display a message (e.g., notification) on a user interface 108 or a user interface 110, which is described in further detail with respect to FIG. 6. The message may include text, such as “Multiple-factor authentication has been activated for your security.” The notification may be accompanied by a visual indicator, such as a lock icon or a change in a status bar color. In some cases, the device 102 may use a banner notification that appears at a top of a user interface 108 or a user interface 110, providing for a user to continue using the device 102 while being aware of a change in the security status (e.g., the activation or deactivation of the multiple-factor authentication). The notification may also include interactive elements, such as a button to review a reason for activation or to temporarily disable additional security measures. The notification may additionally, or alternatively, include audio feedback and/or haptic feedback, such as a vibration, to alert user of the change in the security status.

Thus, the device 102 can adjust authentication processes of the device 102 based on an environment of the device 102 and/or the trusted device 104, reducing manual updates or changes to authentication processes (e.g., by a user). For example, the data manager 116 may collect trusted locations 118, trusted devices 120, and application data 122, among other data, and the multiple-factor authentication system 124 may analyze the collected data to provide for a context-aware approach to security. The multiple-factor authentication system 124 may detect the unsecure conditions 126 and reactivate multiple-factor authentication, which reduces or eliminates unauthorized access to the device 102 while conserving device resources by reducing authentication processes when in secure locations or connected to trusted devices.

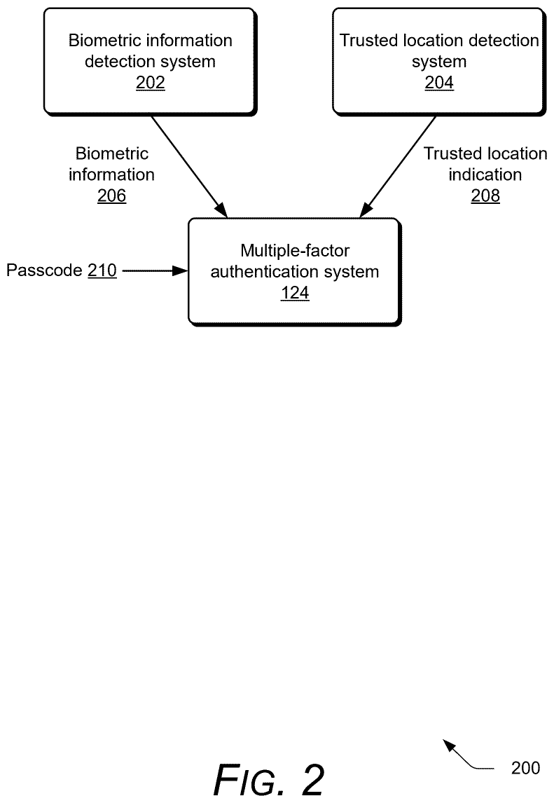

FIG. 2 illustrates an example system 200 for managing multiple-factor authentication based on detected conditions in accordance with one or more implementations as described herein. The example system 200 may implement or be implemented by aspects of the example system 100. For example, the example system 200 can be implemented by a device implementing dynamic activation and deactivation of multiple-factor authentication based on detected conditions, where the device and the multiple-factor authentication system 124 may be examples of a device 102 and a multiple-factor authentication system 124 as described with reference to FIG. 1.

In some examples, the multiple-factor authentication system 124 includes a biometric information detection system 202 and a trusted location detection system 204. The biometric information detection system 202 and the trusted location detection system 204 provide for dynamic security adjustments for a device within a trusted location or when the device is connected to a trusted device, as described with reference to FIG. 1. The biometric information detection system 202 may collect and process biometric information 206 from a user, such as fingerprints, facial features, or voice patterns. For example, the biometric information detection system 202 may collect raw biometric data using sensors. The biometric information detection system 202 may implement different types of sensors depending on capabilities of the device. For example, the biometric information detection system 202 may use a fingerprint scanner integrated into a home button or power button of a device, a front-facing camera for facial recognition on a device, or a microphone for voice pattern analysis on a device. If the multiple-factor authentication system 124 uses the biometric information to verify a user is authorized to access the device, then the multiple-factor authentication system 124 indicates to the biometric information detection system 202 to initiate a data collection process. Upon receiving the signal, the biometric information detection system 202 activates one or more sensors and prompts a user to provide biometric input. For example, the biometric information detection system 202 may display a message indicating for a user to place a finger on a fingerprint scanner or to look at a camera sensor for facial recognition. The biometric information detection system 202 captures the biometric data (e.g., biometric information 206) and processes the biometric data to extract relevant features, converting raw sensory input into a digital representation that can be compared against stored templates.

For example, the biometric information detection system 202 may extract features from the raw data and may convert the features into a digital representation of the biometric information 206. The biometric information 206 may then be transmitted to the multiple-factor authentication system 124 for verification against templates stored on the device. The multiple-factor authentication system 124 may compare the digital representation of the biometric information to a list of trusted digital representations of biometric information 206 to determine whether the user is authorized to access the device. For fingerprint data, the multiple-factor authentication system 124 may analyze ridge patterns and minutiae points to create a unique digital fingerprint template. For facial recognition, the multiple-factor authentication system 124 may map facial features and corresponding spatial relationships to generate a facial signature. The biometric information 206 is then transmitted to the multiple-factor authentication system 124 for verification. The multiple-factor authentication system 124 compares this information against previously stored biometric templates at the device. If the biometric information 206 matches a stored template within a threshold value, then the factor of authentication is successful.

The trusted location detection system 204 may identify when the device is in a location designated as trusted. The trusted location detection system 204 may utilize GPS coordinates, Wi-Fi network identifiers, or cellular information to determine if the device is within a defined trusted location. In some cases, the multiple-factor authentication system 124 queries the trusted location detection system 204 for a location of the device. Upon receiving the query, the trusted location detection system 204 activates location services to obtain current coordinates of the device. The trusted location detection system 204 then compares these coordinates against a database of trusted locations stored on the device. Trusted locations may include a home of a user, a workplace of a user, or other frequently visited secure locations that a user has explicitly designated as trusted. If a current location matches a trusted location within a specified radius (e.g., within 50 meters of a home address of a user), then the trusted location detection system 204 generates a positive trusted location indication 208. This indication is then transmitted to the multiple-factor authentication system 124, which can use this information to deactivate multiple-factor authentication at the device. For example, if the trusted location detection system 204 confirms that the device is at a home address of a user, then the trusted location detection system 204 may send a trusted location indication 208 to the multiple-factor authentication system 124. The multiple-factor authentication system 124 may then deactivate authentication factors, such as bypassing biometric information collection, while still using a passcode 210.

In some examples, the multiple-factor authentication system 124 receives a passcode 210 as input via a user interface. The passcode 210 and the biometric information 206 may serve as the multiple factors in a multiple-factor authentication process. If the multiple-factor authentication process is deactivated, then the device may use one of the passcode 210 or the biometric information 206 to verify whether a user is authorized to access the device. The passcode 210 may include, but is not limited to, a string of characters, numbers, or a combination of both, configured via input.

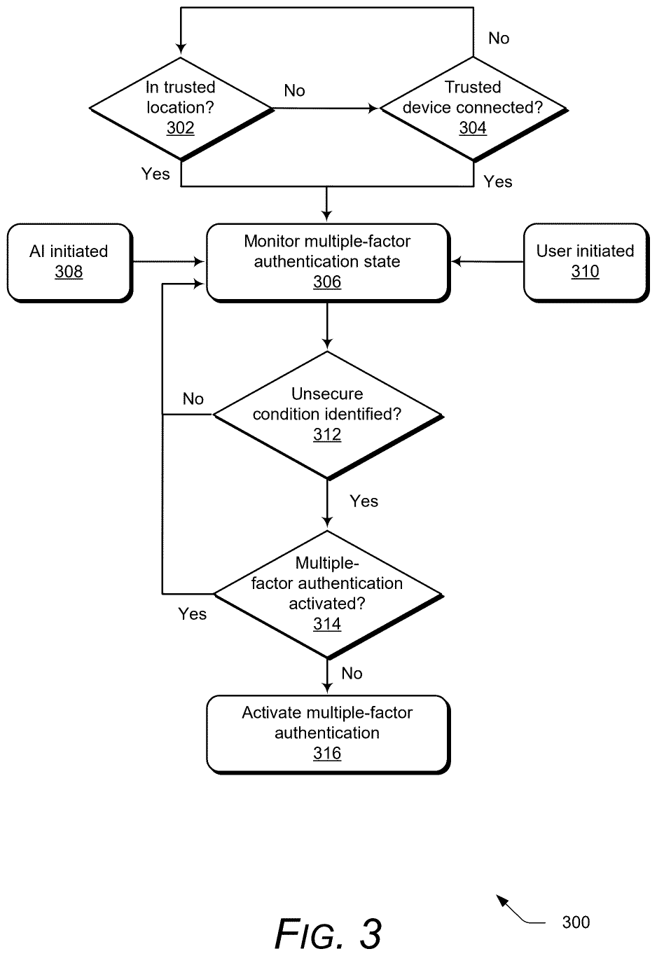

FIG. 3 illustrates an example flowchart 300 for multiple-factor authentication based on detected conditions in accordance with one or more implementations as described herein. The example flowchart 300 may implement aspects of the example system 100 and the example system 200. For example, the example flowchart 300 can be implemented by a device, which may be an example of the device 102 as described with reference to FIGS. 1 and 2. Alternative examples of the following may be implemented, where some processes are performed in a different order than described or are not performed. In some cases, processes may include additional features not mentioned below, or further processes may be added.

At 302, a determination is made as to whether the device is in a trusted location. For example, the device may use the trusted location detection system to determine if the current location of the device matches a stored trusted location, as described with reference to FIG. 2.

At 304, if the device is not in a trusted location (e.g., “No”), then a determination is made as to whether a trusted device is connected. For example, the device may check if it is connected to a trusted device via a wireless connection, as described with reference to FIG. 1.

At 306, if either the device is in a trusted location or a trusted device is connected (e.g., “Yes” from 302 or 304), then the multiple-factor authentication state is monitored. The device may deactivate the multiple-factor authentication and may monitor for unsecure conditions. At 308, the monitoring may be AI initiated, or at 310, the monitoring may be user initiated. For example, a multiple-factor authentication system may analyze application data or sensor data to detect potential security risks, as described with reference to FIG. 1.

At 312, a determination is made as to whether an unsecure condition is identified. For example, the multiple-factor authentication system may detect one of the unsecure conditions. Example unsecure conditions may include, but are not limited to, an event or gathering detected at a trusted location (e.g., a calendar entry for a party or meeting with multiple attendees), detection of unknown Bluetooth, Wi-Fi, or cellular signals within a threshold distance of the device (e.g., indicating the presence of users or devices that are not trusted or authorized to access the device), changes in device motion or orientation that indicate the device is picked up by someone other than the user, changes in network traffic patterns or attempts to access sensitive applications/data, audio sensors detecting multiple voices or unexpected noise levels, and/or image sensors identifying the presence of unknown individuals, among other examples. The device may detect the unsecure conditions by analyzing application data (e.g., calendar entries, messaging history, personal knowledge base or graph data, or social media activity), using device sensors including microphones, cameras, accelerometers, etc. to monitor the environment of the device, scanning for nearby devices and comparing against a list of known trusted devices, monitoring device usage patterns and flagging changes to the patterns, and/or by leveraging machine learning algorithms to identify potential security risks based on aggregated data.

At 314, if an unsecure condition is identified (e.g., “Yes” at 312), then a determination is made as to whether multiple-factor authentication is activated. If the multiple-factor authentication is activated (e.g., “Yes” at 314), then the device continues to monitor for unsecure conditions at 306. If the multiple-factor authentication is not activated (e.g., “No” at 314), then at 316 the multiple-factor authentication is activated. For example, the multiple-factor authentication system may reactivate the previously deactivated authentication factors. If no unsecure condition is identified (e.g., “No” at 312), or after activating multiple-factor authentication at 314, then the device continues monitoring for unsecure conditions at 306.

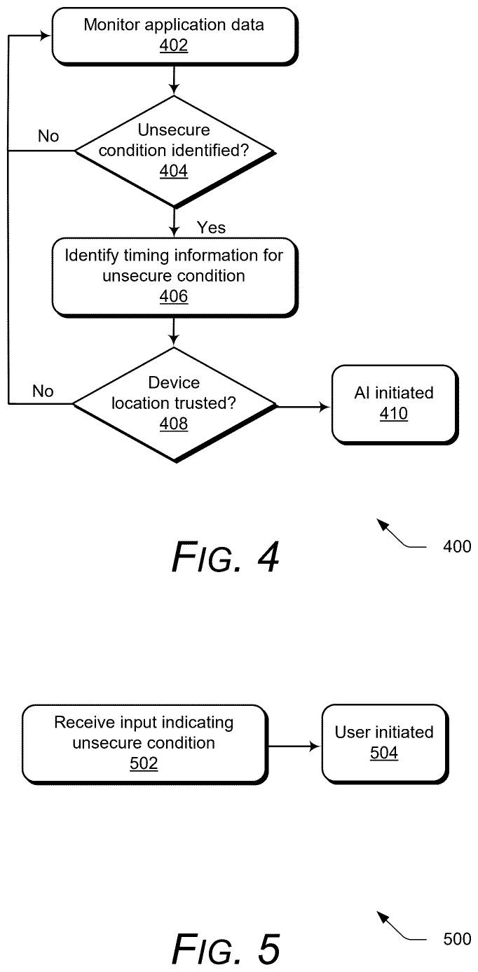

FIG. 4 illustrates an example flowchart 400 for multiple-factor authentication based on detected conditions in accordance with one or more implementations as described herein. The example flowchart 400 may implement aspects of the example system 100, the example system 200, and the example flowchart 300. For example, the example flowchart 400 can be implemented by a device, which may be an example of the device 102 as described with reference to FIGS. 1 and 2. Alternative examples of the following may be implemented, where some processes are performed in a different order than described or are not performed. In some cases, processes may include additional features not mentioned below, or further processes may be added.

At 402, application data is monitored. For example, the device may use the data manager to collect and analyze application data, such as calendar entries, personal knowledge base or graph data, messaging data, or social media activity, as described with reference to FIG. 1. The device may collect and analyze various types of information from different applications to detect patterns or events that indicate potential security risks (e.g., the unsecure conditions). For example, the device may obtain and parse calendar entries to identify scheduled events occurring at trusted locations, such as meetings or other events that involve individuals who may not be authorized to access the device. The device may also analyze messaging data, including text messages, emails, and instant messaging conversations, to detect discussions about upcoming events or changes in plans that affect the security context of the device. Social media activity may be monitored for check-ins, posts, or event information that suggest the user may be in an unfamiliar or unsecure environment. The device may identify pattern changes in application usage, such as increases in data transfer or access attempts to sensitive applications at unusual times or from unexpected locations. Additionally, or alternatively, the device may analyze location data from mapping or navigation apps to identify travel plans or visits to new locations that may lead to heightened security measures. By continuously monitoring and analyzing this application data, the device can proactively identify potential security risks (e.g., unsecure conditions) and adjust its authentication processes, accordingly.

At 404, a determination is made as to whether an unsecure condition is identified based on the monitored data. In some cases, a device may implement AI and/or machine learning to monitor for the application data and to identify the unsecure conditions. For example, the device may implement supervised learning algorithms trained on historical user behavior and known security incidents to classify new patterns as potentially risky or safe. In some other examples, the device may implement unsupervised learning algorithms to detect anomalies in application usage based on patterns in the application data. The device may implement one or more natural language processing models to analyze text-based application data, such as messages, emails, and social media posts. The natural language processing models may identify keywords, phrases, or sentiment indicators that suggest changes in an environment of the device or an event that impacts security of the device. Additionally, or alternatively, the device may implement clustering algorithms to group similar patterns of application usage, providing for the device to identify outliers that may represent unsecure conditions. Additionally, or alternatively, the device may use reinforcement learning techniques to continuously improve a capability of the device to distinguish between application data patterns based on user feedback and outcomes. Additionally, or alternatively, the device may use time series analysis to detect temporal patterns and predict future security risks based on historical application data.

At 406, if an unsecure condition is identified (e.g., “Yes”), then timing information for the unsecure condition is identified. For example, the device may determine the duration or time period during which the detected unsecure condition is expected to occur. If an unsecure condition is not identified (e.g., “No”), then the device may continue to monitor the application data at 402.

At 408, a determination is made as to whether the device location is trusted. For example, the device may use the trusted location detection system to determine if the current location of the device matches a stored trusted location, as described with reference to FIG. 2.

At 410, if the device location is trusted (e.g., “Yes”) during the time period or duration of the unsecure condition, then an AI initiated process is triggered. For example, the multiple-factor authentication system may automatically activate multiple-factor authentication for the duration or the time period in response to detecting an unsecure condition in a trusted location, as described with reference to FIGS. 1 through 3. If the device location is not trusted (e.g., “No”), then the device may return to monitoring application data at 402. For example, the device may determine that multiple-factor authentication is already activated at the device (e.g., due to the device being outside of a trusted location), and therefore the device is secure.

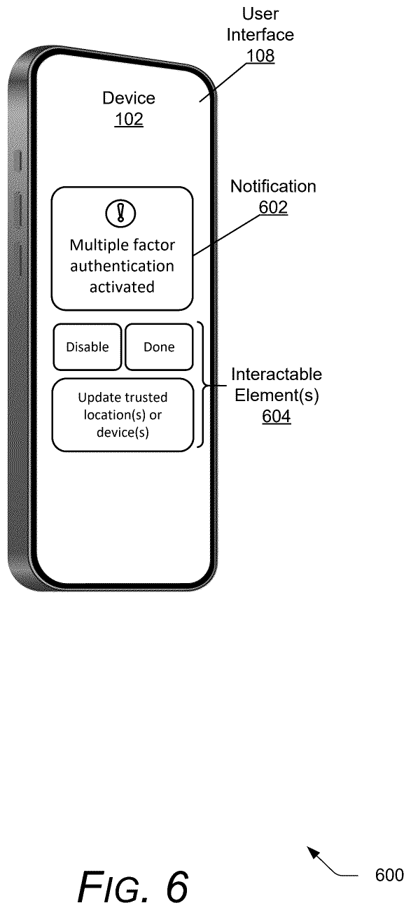

FIG. 5 illustrates an example flowchart 500 for user-initiated multiple-factor authentication based on detected conditions in accordance with one or more implementations as described herein. The example flowchart 500 may implement aspects of the example system 100, the example system 200, and the example flowchart 300. For example, the example flowchart 500 can be implemented by a device, which may be an example of the device 102 as described with reference to FIGS. 1 and 2. Alternative examples of the following may be implemented, where some processes are performed in a different order than described or are not performed. In some cases, processes may include additional features not mentioned below, or further processes may be added.

At 502, input indicating an unsecure condition is received. For example, the device may receive user input via a user interface indicating a potential security risk. A device may be in a trusted location (e.g., at home), where multiple-factor authentication is deactivated. However, the device may receive input (e.g., via a hardware or software button) that indicates for the device to activate multiple-factor authentication. Additionally, or alternatively, the device may receive signaling from a trusted device (e.g., a wearable device connected to the device) that indicates for the device to activate the multiple-factor authentication. In response, the device may display a prompt requesting confirmation of the update to the multiple-factor authentication. The prompt may include text, such as “Do you want to activate multiple-factor authentication?” with selectable options to confirm or cancel. If the user confirms the activation of the multiple-factor authentication, then the device may activate the multiple-factor authentication (e.g., using both a fingerprint scan and passcode entry) for a defined duration.

At 504, a user initiated process is triggered. For example, the multiple-factor authentication system may activate multiple-factor authentication in response to the user input, as described with reference to FIGS. 1 through 3.

FIG. 6 illustrates an example user interface 600 for multiple-factor authentication based on detected conditions in accordance with one or more implementations as described herein. The example user interface 600 may implement aspects of the example system 100, the example system 200, the example flowchart 300, the example flowchart 400, and/or the example flowchart 500. The example user interface 600 may include a device 102 that displays a user interface 108 upon detection of an unsecure condition, where the device 102 and the user interface 108 are examples of the corresponding devices and features as described with reference to FIGS. 1 and 2.

A device 102 may detect an unsecure condition based on application data or sensor data, as described with reference to FIG. 1. Upon detecting the unsecure condition, a multiple-factor authentication system of the device may activate multiple-factor authentication and generate a notification 602 to display via the user interface 108. The notification 602 informs the user that multiple-factor authentication has been activated due to the detection of an unsecure condition.

The notification 602 can include a text value, such as “Multiple factor authentication activated.” Additionally, or alternatively, the notification 602 can include a text value “Multiple factor authentication activated due to detected unsecure condition.” The device 102 can additionally, or alternatively, display one or more interactable elements 604 via the user interface 108. The interactable elements 604 may include a button labeled “Disable” to deactivate the multiple-factor authentication and a button labeled “Done” to dismiss the notification, among other example interactable elements 604.

In some examples, the device 102 may display additional information or controls in the user interface 108. For example, the device 102 may show details about the detected unsecure condition, such as the type of condition detected or the estimated duration of the condition. The device 102 may also display options for the user to review or modify trusted locations or trusted devices, providing quick access to security settings.

If the device receives input selecting the “Disable” interactable element 604, then the device 102 may display a confirmation prompt, warning the user about the potential security risks of disabling multiple-factor authentication in the current environment. The prompt may include options to proceed with disabling authentication or to cancel the action. If the device receives input indicating for the device to proceed, then the multiple-factor authentication system may deactivate the additional authentication factors, reverting to a single-factor authentication method.

In some cases, the user interface 108 may include an “Update trusted location(s) or device(s)” option among the interactable elements 604. When selected, the update trusted locations or devices option may open an interface for managing trusted locations and devices, providing for input to add, remove, or modify entries in response to the detected unsecure condition.

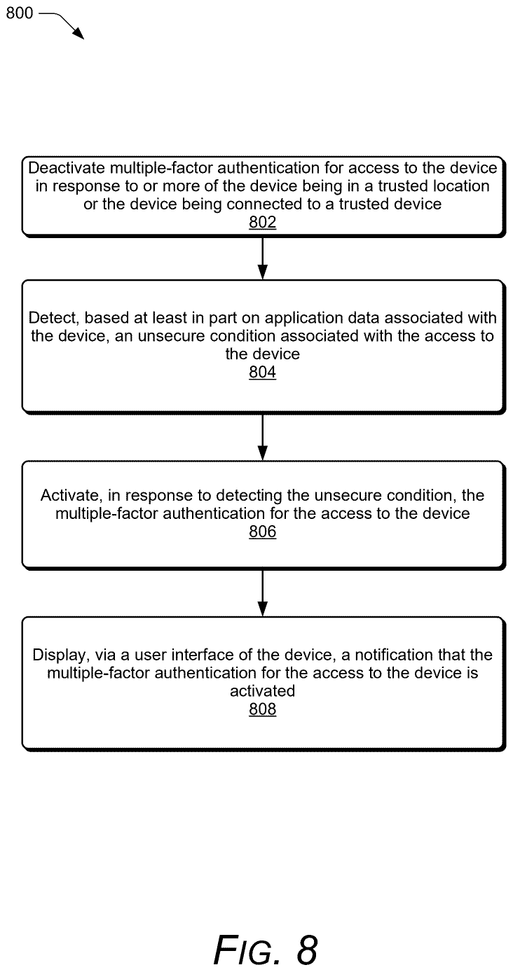

FIG. 7 illustrates one or more example methods 700 for managing multiple-factor authentication based on detected conditions. The order in which the method is described is not intended to be construed as a limitation, and any number or combination of the described method operations can be performed in any order to perform a method, or an alternate method.

At 702, multiple-factor authentication for access to a device is deactivated in response to one or more of the device being in a trusted location or the device being connected to a trusted device. For example, a device deactivates multiple-factor authentication when the device determines the device is within a geographic location designated as trusted or when the device establishes a connection with a device designated as trusted.

At 704, an unsecure condition associated with the access to the device is detected based on application data associated with the device. For example, the device analyzes application data, such as calendar entries, personal knowledge base or graph data, and/or messaging data to identify potential security risks or changes in the environment that may compromise device security.

At 706, the multiple-factor authentication for the access to the device is activated in response to detecting the unsecure condition. For example, upon detecting an unsecure condition, the device reactivates the previously deactivated multiple-factor authentication to enhance security.

In some cases, the device collects data using one or more sensors to indicate the unsecure condition. The sensors may include cameras, microphones, or other environmental sensors that can detect changes in the surroundings of the device. In some implementations, the device receives signaling from an additional device that indicates the additional device is within a threshold distance from the device. The unsecure condition may be based on the additional device being within the threshold distance. The device may display a notification via a user interface that indicates the multiple-factor authentication for access to the device has been activated. In response to this notification, the device may receive input indicating to deactivate the multiple-factor authentication, and subsequently deactivate the multiple-factor authentication. The multiple-factor authentication may include a biometric authentication and a passcode authentication. Biometric authentication can include face recognition, fingerprint recognition, voice recognition, or grip recognition. Passcode authentication may involve a password, a personal identification number, or an input pattern.

In some examples, the device determines the trusted location based on a pattern corresponding to a geographic location of the device. The device may also determine the trusted device based on an identifier associated with the trusted device. The identifier may include, but is not limited to, an address, a unique device identifier, a digital certificate, a firmware version, or a Wi-Fi network identifier associated with the trusted device. Additionally, or alternatively, the identifier may be a cryptographic key or security token exchanged during an initial pairing process between the device and the trusted device. Additionally, or alternatively, the identifier may include a user-designated name or label for the trusted device. The unsecure condition detected by the device may be associated with one or more of an event at the trusted location, an environment of the trusted device, or an environment of the device. This provides for the device to respond to various types of potential security risks in different contexts.

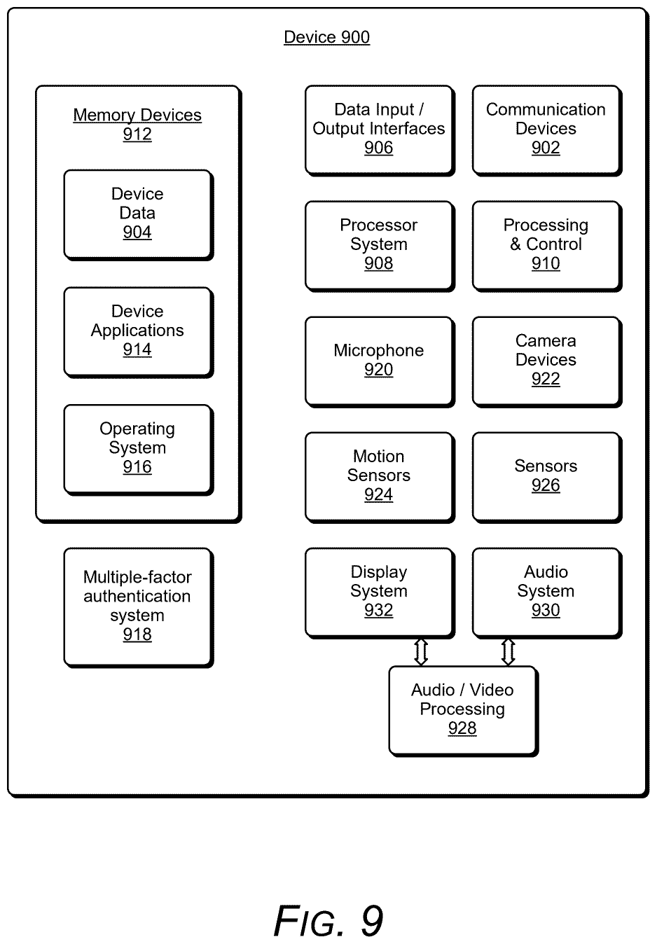

FIG. 8 illustrates one or more example methods 800 for managing multiple-factor authentication based on detected conditions. The order in which the method is described is not intended to be construed as a limitation, and any number or combination of the described method operations can be performed in any order to perform a method, or an alternate method.

At 802, multiple-factor authentication for access to a device is deactivated in response to one or more of the device being in a trusted location or the device being connected to a trusted device. For example, a device deactivates multiple-factor authentication when the device determines the device is within a geographic location designated as trusted or when the device establishes a connection with a device designated as trusted.

At 804, an unsecure condition associated with the access to the device is detected, based at least in part on application data associated with the device. For example, the device analyzes application data such as calendar data, personal knowledge base or graph data, and/or messaging data to identify potential security risks or changes in the environment that may compromise device security.

At 806, the multiple-factor authentication for the access to the device is activated in response to detecting the unsecure condition. For example, upon detecting an unsecure condition, the device reactivates the previously deactivated multiple-factor authentication to enhance security.

At 808, a notification is displayed via a user interface of the device that the multiple-factor authentication for the access to the device is activated. For example, the device may show a message on a screen of the device informing the user that additional security measures have been enabled.

In some cases, the device collects data using one or more sensors to indicate the unsecure condition. The sensors may include cameras, microphones, or other environmental sensors that can detect changes in the surroundings of the device. In some implementations, the device receives signaling from an additional device that indicates the additional device is within a threshold distance from the device. The unsecure condition may be based at least in part on this additional device being within the threshold distance. The multiple-factor authentication may include a biometric authentication and a passcode authentication. Biometric authentication can include face recognition, fingerprint recognition, voice recognition, or grip recognition. Passcode authentication may involve a password, a personal identification number, or an input pattern.

In some examples, the device determines the trusted location based at least in part on a pattern corresponding to a geographic location of the device. The device may also determine the trusted device based at least in part on an identifier associated with the trusted device. The device may receive input from a user that indicates one or more of the trusted location or the trusted device. This provides for users to manually designate locations or devices as trusted. The unsecure condition detected by the device may be associated with one or more of an event at the trusted location, an environment of the trusted device, or an environment of the device. This provides for the device to respond to various types of potential security risks in different contexts. In some variations, the device may receive, in response to the notification, input that indicates for the device to deactivate the multiple-factor authentication. The device may then deactivate the multiple-factor authentication for access to the device based on this input.

The example flowchart 300, the example flowchart 400, the example flowchart 500, the one or more example methods 700, and the one or more example methods 800, are described with reference to respective FIGS. 3, 4, 5, 7, and 8 in accordance with one or more implementations of multiple-factor authentication based on detected conditions, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 9 illustrates various components of an example device 900, which can implement aspects of the techniques and features for multiple-factor authentication based on detected conditions, as described herein. The example device 900 can be implemented as any of the devices described with reference to the previous FIGS. 1 through 8, such as any type of a wireless device, mobile device, mobile phone, flip phone, client device, companion device, paired device, display device, tablet, wearable device, computing, communication, entertainment, gaming, media playback, and/or any other type of computing, consumer, and/or electronic device. For example, the device 102 and/or the trusted device 104, as described with reference to FIGS. 1 through 8, may be implemented as the example device 900.

The example device 900 can include various, different communication devices 902 that enable wired and/or wireless communication of device data 904 with other devices. The device data 904 can include any of the various device's data and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The I/O interfaces 906 can be used to couple the device to any type of components, peripherals, and/or accessory devices, such as a computer input device that may be integrated with the example device 900. The I/O interfaces 906 may also include data input ports via which any type of data, information, media content, communications, messages, and/or inputs can be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 can be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes a multiple-factor authentication system 918 that implements various aspects of the described features and techniques described herein. The multiple-factor authentication system 918 can be implemented with hardware components and/or in software as one of the device applications 914, such as when the example device 900 is implemented as the device 102 described with reference to FIGS. 1 through 8. An example of the multiple-factor authentication system 918 is the multiple-factor authentication system 124 implemented in the device 102, such as a software application and/or as hardware components in the wireless device. In one or more implementations, the multiple-factor authentication system 918 may include independent processing, memory, and logic components as a computing and/or electronic device integrated with the example device 900.

The example device 900 can also include a microphone 920 and/or camera devices 922, as well as proximity and/or motion sensors 924, such as may be implemented as components of an inertial measurement unit (IMU), and geographical location information sensors (e.g., GPS to obtain a current geographic location of the client device or a user of the client device). The proximity and/or motion sensors 924 can be implemented with various sensors 926, such as a gyroscope, an accelerometer, and/or other types of motion sensors to sense motion of the device. The motion sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources, such as when the device is implemented as a wireless device and/or a device 102. The power sources may include a charging and/or power system, and can be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 900. Alternatively, the audio system and/or the display system are external, peripheral components to the example device.

In some aspects, the techniques described herein relate to a device including at least one memory, and at least one processor coupled with the at least one memory and configured to cause the device to deactivate multiple-factor authentication for access to the device in response to or more of the device being in a trusted location or the device being connected to a trusted device, detect, based on application data associated with the device, an unsecure condition associated with the access to the device, and activate, in response to detecting the unsecure condition, the multiple-factor authentication for the access to the device.

In some aspects, the techniques described herein relate to a device, where the application data includes one or more of calendar data that indicates the unsecure condition, personal knowledge base or graph data that indicates the unsecure condition, or messaging data that indicates the unsecure condition.

In some aspects, the techniques described herein relate to a device, where the device further includes one or more sensors, and where the at least one processor is further configured to cause the device to collect, using the one or more sensors, data that indicates the unsecure condition.

In some aspects, the techniques described herein relate to a device, where the at least one processor is further configured to cause the device to receive, from an additional device, signaling that indicates the additional device is within a threshold distance from the device, where the unsecure condition is based on the additional device being within the threshold distance.

In some aspects, the techniques described herein relate to a device, where the at least one processor is further configured to cause the device to display, via a user interface of the device, a notification that the multiple-factor authentication for the access to the device is activated.

In some aspects, the techniques described herein relate to a device, where the at least one processor is further configured to cause the device to receive, in response to the notification, input that indicates for the device to deactivate the multiple-factor authentication and deactivate the multiple-factor authentication for access to the device.

In some aspects, the techniques described herein relate to a device, where the multiple-factor authentication includes a biometric authentication and a passcode authentication.

In some aspects, the techniques described herein relate to a device, where the biometric authentication includes one or more of face recognition, fingerprint recognition, voice recognition, or grip recognition.

In some aspects, the techniques described herein relate to a device, where the passcode authentication includes one or more of a password, a personal identification number, or an input pattern.

In some aspects, the techniques described herein relate to a device, where the at least one processor is further configured to cause the device to determine the trusted location based on a pattern corresponding to a geographic location of the device, and determine the trusted device based on an identifier associated with the trusted device.

In some aspects, the techniques described herein relate to a device, where the at least one processor is further configured to cause the device to receive input that indicates one or more of the trusted location or the trusted device.

In some aspects, the techniques described herein relate to a device, where the unsecure condition is associated with one or more of an event at the trusted location, an environment of the trusted device, or an environment of the device.

In some aspects, the techniques described herein relate to a method, including deactivating multiple-factor authentication for access to a device in response to or more of the device being in a trusted location or the device being connected to a trusted device, detecting, based on application data associated with the device, an unsecure condition associated with the access to the device, and activating, in response to detecting the unsecure condition, the multiple-factor authentication for the access to the device.

In some aspects, the techniques described herein relate to a method, where the application data includes one or more of calendar data that indicates the unsecure condition, personal knowledge base or graph data that indicates the unsecure condition, or messaging data that indicates the unsecure condition.

In some aspects, the techniques described herein relate to a method, further including collecting, using one or more sensors, data that indicates the unsecure condition.

In some aspects, the techniques described herein relate to a method, further including receiving, from an additional device, signaling that indicates the additional device is within a threshold distance from the device, where the unsecure condition is based on the additional device being within the threshold distance.

In some aspects, the techniques described herein relate to a system, including at least one memory, and at least one processor coupled with the at least one memory and configured to cause the system to deactivate multiple-factor authentication for access to the system in response to or more of the system being in a trusted location or the system being connected to a trusted device, detect, based on application data associated with the system, an unsecure condition associated with the access to the system, and activate, in response to detecting the unsecure condition, the multiple-factor authentication for the access to the system.

In some aspects, the techniques described herein relate to a system, where the application data includes one or more of calendar data that indicates the unsecure condition, personal knowledge base or graph data that indicates the unsecure condition, or messaging data that indicates the unsecure condition.

In some aspects, the techniques described herein relate to a system, where the system further includes one or more sensors, and where the at least one processor is further configured to cause the system to collect, using the one or more sensors, data that indicates the unsecure condition.

In some aspects, the techniques described herein relate to a system, where the at least one processor is further configured to cause the system to receive, from a device, signaling that indicates the device is within a threshold distance from the system, where the unsecure condition is based on the device being within the threshold distance.

1. A device comprising:
at least one memory; and
at least one processor coupled with the at least one memory and configured to cause the device to:
deactivate multiple-factor authentication for access to the device in response to or more of the device being in a trusted location or the device being connected to a trusted device;
detect, based at least in part on application data associated with the device, an unsecure condition associated with the access to the device; and
activate, in response to detecting the unsecure condition, the multiple-factor authentication for the access to the device.

2. The device of claim 1, wherein the application data comprises one or more of calendar data that indicates the unsecure condition, personal knowledge base or graph data that indicates the unsecure condition, or messaging data that indicates the unsecure condition.

3. The device of claim 1, wherein the device further comprises one or more sensors, and wherein the at least one processor is further configured to cause the device to collect, using the one or more sensors, data that indicates the unsecure condition.

4. The device of claim 1, wherein the at least one processor is further configured to cause the device to receive, from an additional device, signaling that indicates the additional device is within a threshold distance from the device, wherein the unsecure condition is based at least in part on the additional device being within the threshold distance.

5. The device of claim 1, wherein the at least one processor is further configured to cause the device to display, via a user interface of the device, a notification that the multiple-factor authentication for the access to the device is activated.

6. The device of claim 5, wherein the at least one processor is further configured to cause the device to:
receive, in response to the notification, input that indicates for the device to deactivate the multiple-factor authentication; and
deactivate the multiple-factor authentication for access to the device.

7. The device of claim 1, wherein the multiple-factor authentication comprises a biometric authentication and a passcode authentication.

8. The device of claim 7, wherein the biometric authentication comprises one or more of face recognition, fingerprint recognition, voice recognition, or grip recognition.

9. The device of claim 7, wherein the passcode authentication comprises one or more of a password, a personal identification number, or an input pattern.

10. The device of claim 1, wherein the at least one processor is further configured to cause the device to:
determine the trusted location based at least in part on a pattern corresponding to a geographic location of the device; and
determine the trusted device based at least in part on an identifier associated with the trusted device.

11. The device of claim 1, wherein the at least one processor is further configured to cause the device to receive input that indicates one or more of the trusted location or the trusted device.

12. The device of claim 1, wherein the unsecure condition is associated with one or more of an event at the trusted location, an environment of the trusted device, or an environment of the device.

13. A method, comprising:
deactivating multiple-factor authentication for access to a device in response to or more of the device being in a trusted location or the device being connected to a trusted device;
detecting, based at least in part on application data associated with the device, an unsecure condition associated with the access to the device; and
activating, in response to detecting the unsecure condition, the multiple-factor authentication for the access to the device.

14. The method of claim 13, wherein the application data comprises one or more of calendar data that indicates the unsecure condition, personal knowledge base or graph data that indicates the unsecure condition, or messaging data that indicates the unsecure condition.

15. The method of claim 13, further comprising collecting, using one or more sensors, data that indicates the unsecure condition.

16. The method of claim 13, further comprising receiving, from an additional device, signaling that indicates the additional device is within a threshold distance from the device, wherein the unsecure condition is based at least in part on the additional device being within the threshold distance.

17. A system, comprising:
at least one memory; and
at least one processor coupled with the at least one memory and configured to cause the system to:
deactivate multiple-factor authentication for access to the system in response to or more of the system being in a trusted location or the system being connected to a trusted device;
detect, based at least in part on application data associated with the system, an unsecure condition associated with the access to the system; and
activate, in response to detecting the unsecure condition, the multiple-factor authentication for the access to the system.

18. The system of claim 17, wherein the application data comprises one or more of calendar data that indicates the unsecure condition, personal knowledge base or graph data that indicates the unsecure condition, or messaging data that indicates the unsecure condition.

19. The system of claim 17, wherein the system further comprises one or more sensors, and wherein the at least one processor is further configured to cause the system to collect, using the one or more sensors, data that indicates the unsecure condition.

20. The system of claim 17, wherein the at least one processor is further configured to cause the system to receive, from a device, signaling that indicates the device is within a threshold distance from the system, wherein the unsecure condition is based at least in part on the device being within the threshold distance.
